(19) United States
(12) Patent Application Publication
(10) Pub. No.: US 2016/0376716 A1
(43) Pub. Date: Dec. 29, 2016

(54) METHOD FOR IMPROVING SOLAR ENERGY CONVERSION EFFICIENCY OF SEMICONDUCTOR METAL OXIDE PHOTOCATALYSIS USING H2/N2 MIXED GAS PLASMA TREATMENT

(71) Applicant: Korea Advanced Institute of Science and Technology, Daejeon (KR)

(72) Inventors: Jeung Ku KANG, Daejeon (KR); Dong Ki LEE, Daejeon (KR); Gyu Heon LEE, Daejeon (KR); Yong-Hoon KIM, Daejeon (KR); Ji Il CHOI, Daejeon (KR)

(21) Appl. No.: 14/925,431

(22) Filed: Oct. 28, 2015

(30) Foreign Application Priority Data
Jun. 29, 2015 (KR) 10-2015-0091886

(51) Int. Cl. C25B 11/04

(52) U.S. Cl. CPC C25B 11/0478; G01N 27/30

(57) ABSTRACT

Disclosed is a method for improving solar energy conversion efficiency of a metal oxide semiconductor photocatalyst, which includes rapidly performing hydrogenation and nitrogenation of a metal oxide semiconductor material through an H₂/N₂ mixed gas plasma treatment in a single process at room temperature, so as to enhance photocatalytic energy conversion efficiency. Specifically, disclosed is a treatment technique in which a plasma ball formed by controlling a mixing ratio of hydrogen gas to nitrogen gas in a range of 1:1 to 1:3 contacts with a surface of a metal oxide material, such that a great amount of oxygen vacancy and nitrogen elements are introduced in the surface of the metal oxide material to improve electron-hole pairs transfer ability thereof and decrease a size of the band-gap. A catalyst including the metal oxide material directly converts the solar energy into a compound by photocatalytic hydrogen generation and CO₂ conversion.

### CROSS REFERENCE TO RELATED APPLICATIONS

This application claims priority to Korean Patent Application No. 10-2015-0091886, filed on Jun. 29, 2015 in the Korean Intellectual Property Office, the entire disclosure of which is incorporated herein by reference.

### TECHNICAL FIELD

The present invention relates to a treatment technique for improving photocatalytic energy conversion efficiency of a metal oxide semiconductor through hydrogen/nitrogen (H₂/N₂) mixed gas plasma treatment.

Conventionally, the metal oxide semiconductor as a photocatalyst has involved drawbacks such as a high electron-hole recombination rate and a wide band-gap. In order to solve the above problems, the present invention includes: a first process of preparing metal oxide nanoparticles in a thin film; and a second process of performing an H₂/N₂ mixed gas plasma treatment on the metal oxide thin film. Herein, by mixing H₂ and N₂ gases and performing plasma treatment of the gas mixture, different types of nitrogen hydride radicals (NHₓ⁺) as well as hydrogen radicals (H⁺) and nitrogen radicals (N⁺) are formed. In addition, contacting an outer face of a plasma sphere containing such highly reactive radicals as described above with a surface of the metal oxide thin film may rapidly improve photocatalytic properties and energy conversion efficiency of the metal oxide semiconductor in a single process at room temperature.

The H₂/N₂ mixed gas plasma treatment process proposed in the present invention may be possibly applied to a broad range of metal oxide semiconductor photocatalysts including, for example, TiO₂, ZnO, WO₃, SnO₂, etc. In addition, any material treated by the above process may have some characteristics of: 1) extended range of absorbable light wavelengths, 2) increased major carrier density, 3) enabling fast transfer of excited electron-hole pairs to an outside before these are recombined and disappear, and 4) improving overall oxidation/reduction reaction characteristics of the metal oxide, and thereby, can be employed in a broad range of applications including not only solar energy conversion catalysts but also other different catalyst fields based on the metal oxide semiconductor such as electro-chemical energy conversion and storage, gas detection, or the like.

### BACKGROUND

Carbon capture and utilization (CCU) is an advanced eco-friendly energy circulation technique, which is based on the photosynthesis principle in nature to produce different hydrocarbon compounds such as carbon monoxide (CO), methane (CH₄), methanol (CH₃OH), formic acid (HCOOH), etc. by using solar energy, water and CO₂. The purpose of the CCU technique is essentially to develop a photocatalyst with the possibility of realizing an artificial photosynthesis technique that oxidizes water (H₂O) with received solar energy, and at the same time, reduces CO₂. The metal oxide photocatalyst including representative examples such as TiO₂ or ZnO has excellent economic advantages, chemical stability, durability and non-harmful effects on the human body and environment, compared to other catalytic materials. Nevertheless, as a result, due to very low solar energy conversion efficiency, utilization of the above technique has been limited.

Major reasons of the low energy conversion efficiency may be as follows: 1) due to the wide band-gap, only solar light in the UV range can be used as an energy source, therefore, 4% of the whole solar spectrum is used at most; and 2) due to characteristics of semiconductor materials, the photogenerated electron-hole pairs cannot be reliably separated and have a high probability of recombination, this results in minimal utilization in final oxidation/reduction reactions.

In order to overcome such factors causing a decrease in efficiency as described above, a representative method may include introducing different metal and non-metal elements into a crystalline structure of existing metal oxides to vary a binding energy or charge density between constituent atoms inside the crystal, thereby reducing a size of the band-gap and enhancing an electron-hole transfer rate. However, in case of introducing metal elements, a conduction band minimum (CBM) level essential in the reduction reaction of CO₂ and H₂ is significantly changed. On the other hand, when introducing non-metal elements, a number of defect sites which cause an increase in the electron-hole recombination rate are generated in the crystalline structure. Therefore, each of the above treatments still requires additional complementary processes.

Accordingly, the present invention provides a simple treatment method that utilizes hydrogenation and nitrogenation processes to improve overall electron-hole pair transfer properties, while decreasing the size of the band-gap to increase an applicable wavelength range.

The conventional hydrogenation process has been executed by exposing a metal oxide material under a hydrogen gas atmosphere at high temperature and high pressure (200° C., 10 bar or more), for at least one day. Further, the conventional nitrogenation process has been mostly executed by treating an ammonia gas at a high temperature of at least 500° C. for 1 hour or more.

However, when these two processes are separately conducted, the non-metal elements introduced in the metal oxide crystals are released out of the crystals at a temperature of 300° C. or more, therefore, desired effects cannot be achieved. On the other hand, when these two processes are conducted in combination, high reactive gases are mixed at a high temperature to cause a danger of explosion, hence entailing limitations in the practical use thereof.

In order to overcome the above-described limitations, the present invention provides a method of performing sufficient hydrogenation and nitrogenation required for enhancing photocatalytic properties in a single process at room temperature within 3 minutes by utilizing formation of different types of hydrogenated nitrogen radicals (NHₓ⁺) as well as hydrogen and nitrogen radicals (H⁺ and N⁺) when H₂ and N₂ gases are mixed to cause a plasma reaction.

TiO₂ nanoparticles treated by an H₂/N₂ mixed gas plasma treatment process provided according to the present invention may have some characteristics of: 1) extended photoactive wavelength to the visible light region while preserving a required energy band level for CO₂ reduction and water oxidation; 2) noticeably increased electron carrier density; 3) quick transfer of electron-hole pairs out of the nanoparticles due to new energy levels created by the above-described plasma treatment before the electron-hole pairs excited by light energy are recombined and disappear; and therefore, 4) remarkably enhancing overall oxidation/reduction reaction properties of the metal oxide. As a result, the solar energy conversion efficiency may be remarkably increased, compared to untreated TiO₂ nanoparticles.

Although the same prior art as the present invention is not yet disclosed, some conventional arts similar thereto may be described as follows:

1) Korean Patent Registration No. 10-0950623 (a method for increasing compression stress of PECVD silicon nitride films): a technique for enhancing compression stress characteristic of a silicon-nitride coating film, which includes depositing a silicon-containing precursor on a semiconductor element by treatment of the precursor using H₂ gas plasma and mixed plasma of H₂ and N₂ gases, in a sequential order.

3) Korean Patent Registration No. 10-1058735 (a solar cell and a method of manufacturing the same): a technique for manufacturing a solar cell electrode with enhanced passivation effects, which includes forming an insulating film having a hydrogen content of less than 10% on the surface of a semiconductor electrode through silane and ammonia mixed gas plasma treatment.

3) Korean Patent Registration No. 10-1310865 (a method and an apparatus for manufacturing a nanoparticle composite catalyst by plasma ion implantation): a technique for manufacturing a homogenized nanoparticle composite catalyst using a small amount of catalyst components, which includes injecting solid elements instantly ionized through solid element plasma ion implantation into a porous carrier substrate.

4) Korean Patent Registration No. 10-0510049 (a simultaneous desulfurization and denitrogenation method using a combination process of low temperature plasma and low temperature catalyst, and an apparatus used for the same): a technique for neutralizing nitrogen oxides and sulfur oxides contained in an exhaust gas, followed by removing the same through catalysis, which includes charging the exhaust gas in a low temperature plasma reactor filled with ammonia and propylene.

Other than the above four patent cases proposed as the representative examples, most of the conventional arts are concentrated on the improvement of physical properties, neutralization and treatment of harmful gases, and production of nanoparticles and a uniform coating film, which are substantially independent of the present invention with the purpose of improving photochemical catalytic conversion properties. Further, these patents have essential differences in technical configurations, as compared to those of the present invention, that is, application of two different element treatment characteristics in a single process, which is intended for realization through the mixed gas plasma treatment.

Further, other similar conventional arts disclosed in research papers are as follows:

1) Enhancing Visible Light Photo-oxidation of Water with TiO₂ Nanowire Arrays via Cotreatment with H₂ and NH₃: Synergistic Effects between Ti³⁺ and N (J. Am. Chem. Soc. 2012, 134, 3659): a technique for hydrogenation and nitrogenation of TiO₂ nanowires by sequentially treating the same with hydrogen and ammonia gases at 500° C. for 1 hour, respectively.

2) Core-Shell Nanostructured Black Rutile Titania as Excellent Catalyst for Hydrogen Production Enhanced by Sulfur Doping (J. Am. Chem. Soc. 2013, 135, 17831): a technique including heat treatment of TiO₂ nanoparticles with aluminum at 800° C. for 6 hours to conduct reduction of the surface of the nanoparticles, followed by flowing H₂S gas at 600° C. for 4 hours to inject a sulfur element into TiO₂ while providing hydrogenation-like effects thereto.

3) Effective nonmetal incorporation in black titania with enhanced solar energy utilization (Energy Environ. Sci. 2014, 7, 967): application of various elements for implantation such as hydrogen, sulfur, iodine and nitrogen, in the same technical method as disclosed in the research paper of 2).

These published research papers describe effects similar to those achieved by the technique proposed in the present invention. However, in methodological aspects for embodying functional effects, the conventional arts have employed reactive gases such as ammonia, hydrogen sulfide, etc., and involved hydrogenation of metal oxides and the introduction of other non-metal elements through at least two separate processes at a high temperature of 500° C. or more for a relatively long time of 1 hour or more. Therefore, such technical methods as described above are significantly different from the method proposed and realized by the present invention.

### SUMMARY OF THE DISCLOSURE

A metal oxide semiconductor photocatalyst has excellent performance in aspects of being economical, durability and reaction stability, however, also entails some disadvantages including: only 4% usability of solar energy incident on a ground surface due to a wide band-gap and high electron-hole recombination; and considerably limited number of electron-holes participating in final redox reaction to thus exhibit a very low numerical value of solar energy conversion efficiency. Among representative methods for improving such low energy conversion efficiency, there have been proposed a variety of illustrative examples to introduce metal/non-metal elements into metal oxide crystals. However, these methods did not overcome the above-two described problems, hence still requiring additional complementary treatment.

The present invention includes first and second processes as described below: the first process of preparing metal oxide nanoparticles in a thin film; and the second process of performing an H₂/N₂ mixed gas plasma treatment on the metal oxide thin film.

In this regard, the finally processed metal oxide nanoparticles include a great amount of oxygen vacancy and nitrogen elements introduced in the surface thereof to thus exhibit a dark surface and have irregularly varied structure of crystals in a physical aspect, while decreasing a size of the band-gap and improving electron-hole pairs transfer ability. Consequently, the present invention provides a method for manufacturing metal oxide nanoparticles with enhanced photocatalytic reaction abilities.

According to a method for manufacturing hydrogenated and nitrogenated metal oxide of the present invention, the first process may include: utilizing any deposition method such as electrophoresis and etching, spin coating, doctor blading, sputtering, atomic layer deposition (ALD), etc. to deposit a metal oxide layer on a top of a substrate (support) in a thin film form; and thermal treatment of the metal oxide thin film layer and substrate in a temperature range of less than their phase transition temperature, so as to improve the binding force between the metal oxide layer and the substrate.

According to the method for manufacturing hydrogenated and nitrogenated metal oxide of the present invention, the second process may include: placing the prepared metal oxide thin film in a reactor of an apparatus for microwave plasma enhanced-chemical vapor deposition (MPE-CVD); and contacting a plasma ball generated by the plasma reaction of H₂/N₂ mixed gas with the surface of the prepared metal oxide thin film and treating the same.

In order to achieve the above-described objects, the present invention provides a method for manufacturing a metal oxide catalyst including hydrogenation and nitrogenation of metal oxide, characterized by having an extended wavelength of photoactive range, and increases in electron carrier density and electron-hole separation rate.

Technical objects of the present invention are not particularly limited to those described above, and other technical objects not described herein will also be clearly understood by a person who has a common knowledge in the technical field to which the invention pertains.

According to the present invention, H₂/N₂ mixed gas plasma treatment may enable hydrogenation and nitrogenation of the metal oxide to be efficiently performed by a single process at room temperature in a short time, thereby maximizing catalytic properties of the metal oxide.

When a hydrogen is introduced into the metal oxide, a great amount of oxygen vacancy is generated on the surface of the metal oxide to greatly increase an electron carrier density and separate the photogenerated electron-hole before these are recombined and disappear.

Further, when a nitrogen is introduced to a metal oxide by substituting oxygen, a mid-gap state is formed at a level higher than the VBM level of the existing metal oxide. Accordingly, similar to the above-described hydrogenation effects, it may exhibit effects of fast separating holes from the photogenerated electron-hole pairs before these are recombined and disappear.

Further, when a nitrogen does not substitute for an oxygen but is introduced between a metal element and the oxygen element, it may up-shift a valence band maximum (VBM) level while preserving initial conduction band minimum (CBM) level, so as to extend a photoactive wavelength range, thereby possibly using solar energy at a wider wavelength band.

Through the H₂/N₂ mixed gas plasma reaction proposed by the present invention, high-active NHₓ radicals as well as H and N radicals are generated. A direct contact between the plasma balls and the top-surface of as-prepared metal oxide thin film can provide facile treatment condition for one-step hydrogenation and nitrogenation of metal oxide at room temperature in a short time.

Further, due to characteristics of the treatment method according to the present invention, the above-described hydrogenation and nitrogenation effects are mostly concentrated on the surface of particles in the metal oxide, resulting in a heterojunction core/shell structure while preserving initial characteristics of metal oxide, as shown in FIG. 2. As a result, the number of photoexcited electrons and holes at the surface of the particles is greatly increased. In addition, photoexcited electrons and holes inside of particles can be rapidly transported to the surface by the energy levels created at the surface (see FIG. 3).

Accordingly, compared to untreated metal oxide, the amount of electrons and holes participating in oxidation/reduction catalysis is significantly increased to thus remarkably improve the catalysis efficiency.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating gas plasma treatment of a metal oxide thin film sample using a MPE-CVD device in the manufacturing process according to the present invention, wherein different colors of a ball generated through a plasma reaction depending on types of gases injected inside a reactor (hydrogen: dark blue, nitrogen: pink, hydrogen+nitrogen: violet) are shown through the view port. The different colors of the each plasma reaction indicated that the different types of radicals were created depending on the reaction gases.

FIG. 2 is a view illustrating a process in which a TiO₂ nanoparticle is changed to the HN—TiO₂ nanoparticle by the H₂/N₂ mixed gas plasma treatment;

FIG. 3 is a view illustrating energy levels formed at the surface of the TiO₂ nanoparticle by hydrogenation and nitrogenation using an H₂/N₂ mixed gas plasma, as compared to an energy level of reversible hydrogen electrode (RHE), and effects resulting from the same;

FIG. 4 is views illustrating: a) measured results of light absorbance before (bare TiO₂) and after (HN—TiO₂) H₂/N₂ mixed gas plasma treatment converted into Tauc relationship, as well as photographs of samples; b) interplanar distances measured along different color arrows shown in FIGS. 4c and 4d; and c) and d) TEM measurement photographs of bare TiO₂ nanoparticle and HN—TiO₂ nanoparticle, respectively;

FIG. 5 is views illustrating: a) NEXAFS measurement results of oxygen K-edge of samples treated with hydrogen (H—TiO₂), nitrogen (N—TiO₂) and H₂/N₂ mixed gas (HN—TiO₂) plasmas, respectively; b) NEXAFS measurement results of nitrogen K-edge of HN—TiO₂ sample, and an inset showing XPS measurement of nitrogen is orbital; and c) valance band (VB) XPS measurement results of the sample before and after H₂/N₂ mixed gas plasma treatment;

FIG. 6 is views illustrating changes in photoelectrochemical catalytic properties of the sample along with changes in process conditions of the H₂/N₂ mixed gas plasma treatment, wherein: a) plasma output power; b) processing time; and c) a mixing ratio of H₂ and N₂ gases, respectively, which are expressed by photocurrent-voltage curves with 0.1 M NaClO₄ (pH 7) aqueous solution; and

FIG. 7 is views illustrating: a) photoelectrochemical catalytic properties of a sample (HN—TiO₂) having received the gas plasma treatment using H₂/N₂ mixed gas in a mixing ratio of 2:1 at 500 W output power for 3 minutes and another sample (bare TiO₂) without the same treatment, which are expressed by the photocurrent-voltage curves with 0.1 M NaClO₄ (pH 7) aqueous solution; and b) incident photon-to-electron efficiency (IPCE) curves at the potential of water oxidation (1.23 V_{RHE}), and the insets showing normalized photocurrent-time curves of bare TiO₂ and HN—TiO₂.

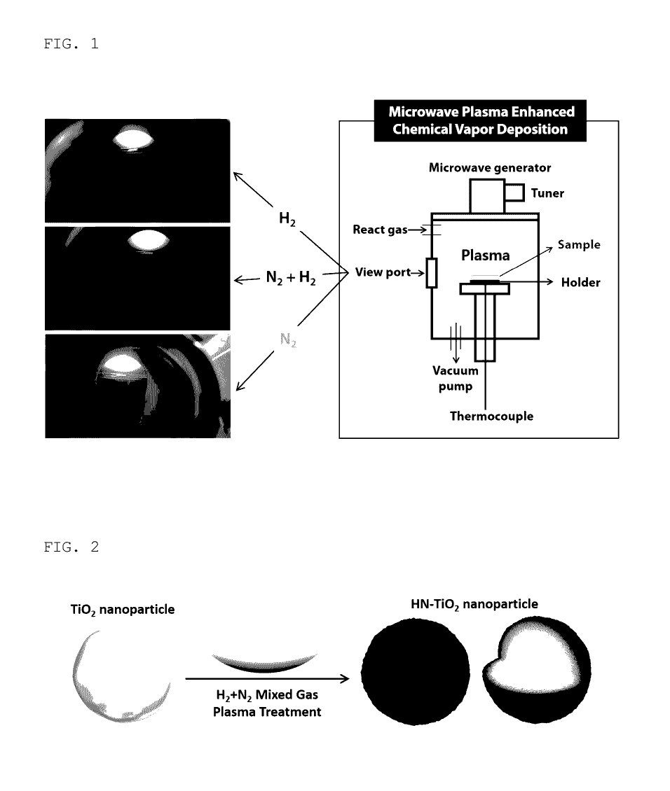

### DETAILED DESCRIPTION OF THE INVENTION

The present invention provides a treatment method for improving catalytic properties of metal oxide by greatly increasing the number of electrons/holes possibly participating in desired catalysis, which includes rapid and simple hydrogenation and nitrogenation of a metal oxide through an H₂/N₂ mixed gas plasma reaction in a simple process at room temperature.

The metal oxide proposed by the present invention is not particularly limited to titanium dioxide (TiO₂) but may include any metal element having n-type semiconductor properties, and may be broadly employed to improve catalytic properties of the metal oxide consisting of at least one selected from Ti, V, Fe, Ni, Cu, Zn, Sn, Ta, W and Bi.

### Example

100 mg of anatase TiO₂ nanoparticles having a particle diameter of about 25 nm was sufficiently dispersed in 50 ml of acetone solution containing 20 mg of iodine dissolved therein. Two nickel foils were immersed in the prepared solution so as to face each other, and then, 100V DC was applied to the same for 1 minute, to form a TiO₂ nanoparticle thin film layer having a thickness of about 250 nm on the nickel foil side of a negative electrode. The TiO₂ thin film sample was subjected to heat treatment at 500° C. under an air atmosphere for 40 minutes to improve adhesion between the thin film layer and the nickel foil substrate.

The as-prepared metal oxide thin film was placed in a reactor of a chemical vapor deposition device (e.g. a microwave plasma enhanced chemical vapor deposition, MPE-CVD) for possible gas plasma treatment, and prepared to be under a vacuum atmosphere of 3×10⁻³ Torr or less. Thereafter, while flowing a mixed gas containing H₂ and N₂ gases in a mixing ratio of 1:2 into the reactor at an overall 100 sccm flow rate, an outer surface of a plasma sphere containing H, N and NHₓ radicals formed thereon has contacted with the surface of the metal oxide thin film by causing a gas plasma reaction under a condition of 500 W output power and controlling the same, followed by maintaining this state for 3 minutes. Herein, a distance between the plasma ball and the surface of the metal oxide thin film is controlled through atmospheric control inside the reactor. This distance is substantially different according to a thickness of the overall thin film including the substrate and the metal oxide layer, type and flow rate of a reactive gas, output power for plasma generation, etc., and therefore, may be variably controlled in a range of 1 to 30 Torr. Furthermore, a contact time between the plasma sphere and the surface of the metal oxide thin film may also be variably controlled according to a desired degree of treatment. In addition, H₂ and N₂ gases may be controlled in a mixing ratio of 1:1, 1:2 or 1:3.

### Experimental Example

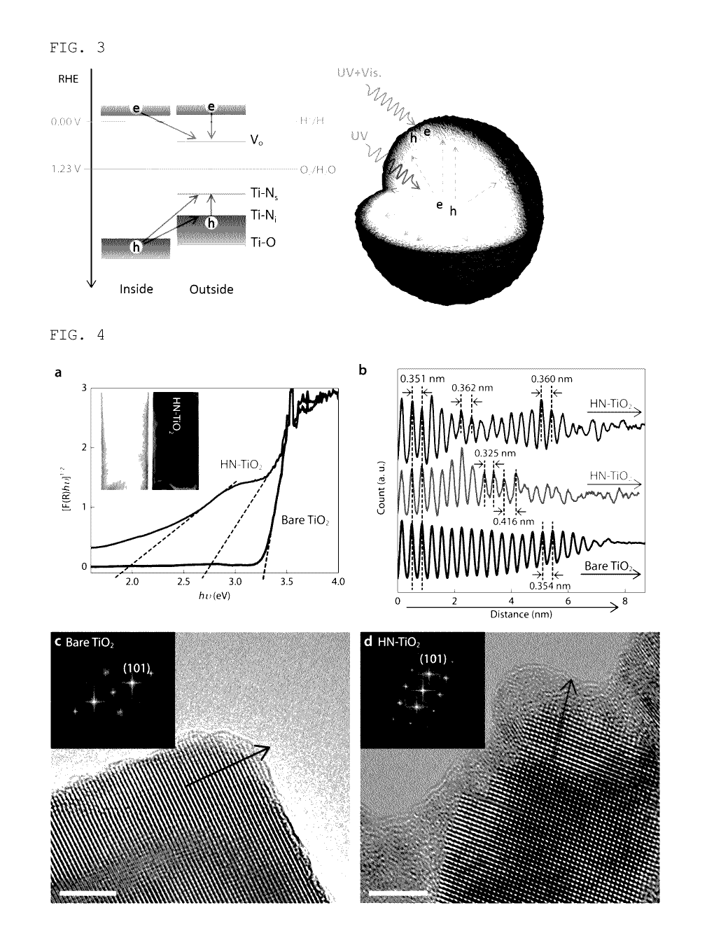

FIG. 4 illustrates changes in light absorbance and crystallinity between a TiO₂ nanoparticle (HN—TiO₂) with an H₂/N₂ mixed gas plasma treatment according to the above-described method and a TiO₂ nanoparticle (bare TiO₂) without any treatment. As shown in the inset of FIG. 4a, a conventional white TiO₂ thin film changed into a dark yellow color by the plasma treatment and showed a great increase in light absorbance characteristics in a visible light region after plasma treatment, as observed in the light absorbance curve of each sample in FIG. 4a, which was prepared using the Tauc relationship. As a result of calculating a size of the band-gap for each sample using x intercepts of the graph shown in FIG. 4a, it was observed that the bare TiO₂ had 3.27 eV while HN—TiO₂ showed a decrease to 2.71 eV. Further, existence of an additional band-gap with a size of 1.92 eV was observed.

FIGS. 4c and 4d illustrate transmission electron microscopy (TEM) photographs of a single nanoparticle in each sample, respectively. The bare TiO₂ nanoparticle in FIG. 4c showed the same anatase 101 plane in both of the inside and the outside of the nanoparticle, however, the HN—TiO₂ in FIG. 4d showed that a crystalline structure of the anatase 101 plane is maintained on the inside while the outside thereof was observed to have irregularly altered crystalline properties. Further, FIG. 4b also illustrates results of an interplanar distance measured along the arrows shown in FIGS. 4c and 4d. Red and blue curves in FIG. 4b show the interplanar distance measured along the arrows with these colors, respectively, present in TEM photographs of HN—TiO₂ nanoparticle in FIG. 4d, while a black curve shows the interplanar distance measured along the arrow in FIG. 4c. All of the three curves have the same interplanar distance inside the particle of 0.351 nm to indicate the anatase 101 face. However, for HN—TiO₂, it was observed that the interplanar distance changes irregularly from the minimum of 0.325 nm to the maximum of 0.416 nm toward the outside thereof. Due to this phenomenon, a Fourier transformed TEM photograph as the inset of FIG. 4d illustrated that a white elliptical trace indicating the anatase 101 plane is observed around diffraction points. Meanwhile, the bare TiO₂ showed that the interplanar distance is 0.354 nm near the surface thereof, which slightly increases as compared to the existing interplanar distance. Based on the above-observed results of the changes in light absorption properties and crystallinity, effects of the mixed gas plasma treatment proposed by the present invention have been mostly concentrated on the surface of particles, as shown in FIG. 2. On the other hand, the inside of the particle maintains inherent characteristics of the anatase phase TiO₂.

FIG. 5 illustrates measured results of changes in chemical states of elements forming the surface of TiO₂ nanoparticles by the gas plasma treatment. Anatase phase TiO₂ has titanium 3d orbital and oxygen 2p orbital hybridized by a crystal field effect to form a hybrid orbital level having an energy level in T_{g} and e_{2g} states above the Fermi energy level. Accordingly, in a near edge X-ray absorption fine structure (NEXAFS) curve obtained by measuring the chemical state of an oxygen K-edge in FIG. 5a, the bare TiO₂ showed peaks indicating T_{g} and e_{2g} levels at a photon energy in a range of 530 eV to 535 eV. Further, it was observed that a and c peaks are present in a hybrid orbital level formed by hybridization of an oxygen 2p orbital and titanium 4s or 4p orbital at a high photon energy. Such specific peaks observed in the anatase phase TiO₂ did not show any significant differences when performing an H₂ gas plasma treatment (H—TiO₂). However, when performing an N₂ gas plasma treatment (N—TiO₂), the positions of t_{g} and e_{2g} level peaks moved toward the right side and the depth of a valley between these two peaks was decreased. Further, it was observed that the form of the a and c peaks is significantly changed.

The above changes are further increased when performing the H₂/N₂ mixed gas plasma treatment (HN—TiO₂), and a new peak was observed at the b position between the a and c peaks. As a result, an overall outline of the curve was altered into the morphology similar to the oxygen K-edge spectrum of surface-oxidized titanium nitride (TiN) or titanium nitrate (TiON).

Referring to the NEXAFS curve of a nitrogen K-edge of the HN—TiO₂ sample shown in FIG. 5b, it was observed that a nitrogen introduced by the plasma treatment is combined with a titanium to form a new orbital level. As described for the case of oxygen, two peaks found near 400 eV among such orbital levels exhibit a t_{g} and e_{2g} hybrid orbital level generated by the hybridization of the nitrogen 2p orbital and titanium 3d orbital. Likewise, ‘a’ peak near 410 eV is also a specific peak which is generated in the hybrid orbital level and formed by the hybridization of the nitrogen 2p orbital and titanium 4s or 4p orbital. The inset of FIG. 5b shows the chemical status of the nitrogen is orbital measured by X-ray photoelectron spectroscopy (XPS). Similar to the NEXAFS results, the nitrogen-titanium (N—Ti) combined peak was the highest peak and other nitrogen-oxygen (N—O) and nitrogen-hydrogen (N—H) combined peaks were further confirmed. Such nitrogen XPS and NEXAFS measured results demonstrated that nitrogen is introduced in two different modes, that is, an oxygen atom is substituted with nitrogen in an anatase crystal or nitrogen invades between oxygen and titanium atoms, and different energy levels are formed in relation to the respective introduction conditions. Meanwhile, it was found that the intensity of peaks indicating oxygen vacancy in the HN—TiO₂ sample sharply increases, compared to the bare TiO₂, by measuring the chemical states of the XPS oxygen is orbital.

In order to determine the position of the energy level generated by such a nitrogen introduction effect as described above, a valance band XPS was measured and the measured result is shown in FIG. 5c. It was found that HN—TiO₂ has a VBM level at a 0.6 eV lower position, as compared to the bare TiO₂. Further, due to an energy level newly formed at a 0.6 eV lower position than the VBM, a sharp peak was observed. As such, according to a calculation method based on density functional theory (DFT), it was demonstrated that new energy levels discovered in HN—TiO₂ are the energy levels formed by combining substitutional nitrogen (Nₛ), which was introduced in substitution mode, and interstitial nitrogen (Nᵢ), which was introduced in invasion mode, with titanium atoms. With reference to the results in FIG. 4a, assuming that a band-gap of the anatase phase TiO₂ is 3.27 eV, band-gaps due to the energy level formed by the combination of Ti—Nₛ and Ti—Nᵢ in the HN—TiO₂ sample measured by VB XPS have the size of 2.67 eV and 1.97 eV, respectively. It was determined that these results are very similar to 2.71 eV and 1.92 eV which are the band-gap levels of HN—TiO₂ calculated on the basis of light absorption properties in FIG. 4a.

Meanwhile, a flat band level difference between two samples calculated by the Mott-Schottky measurement method was determined as 0.03 eV, therefore, it was found that the CBM level of HN—TiO₂ was changed by 0.03 eV, compared to the bare TiO₂.

With reference to the above data, FIG. 3 illustrates a graph of the band-gap structure including all energy levels in the HN—TiO₂ sample, compared to the reversible hydrogen electrode (RHE) level. For reference, when the density of oxygen vacancy in an n-type semiconductor metal oxide is too high, Vₒ is an energy level generated at a point of 0.8 eV below the CBM, which is a feature of hydrogenated metal oxide. Due to the Vₒ energy level, an effect in which the plasma-treated sample turns dark has occurred. According to the Ti—Nₛ, and Vₒ energy levels formed on the surface of the particle shown in FIG. 3, the electron-hole pairs excited inside the particle are effectively transferred to the surface of the particle. In addition to this effect, as the VBM of TiO₂ is increased by Ti—Nᵢ, the size of the band-gap is decreased to extend a wavelength band, at which the electron-hole pairs are generated by sensing the light, to another wavelength band of about 470 nm in a visible light region.

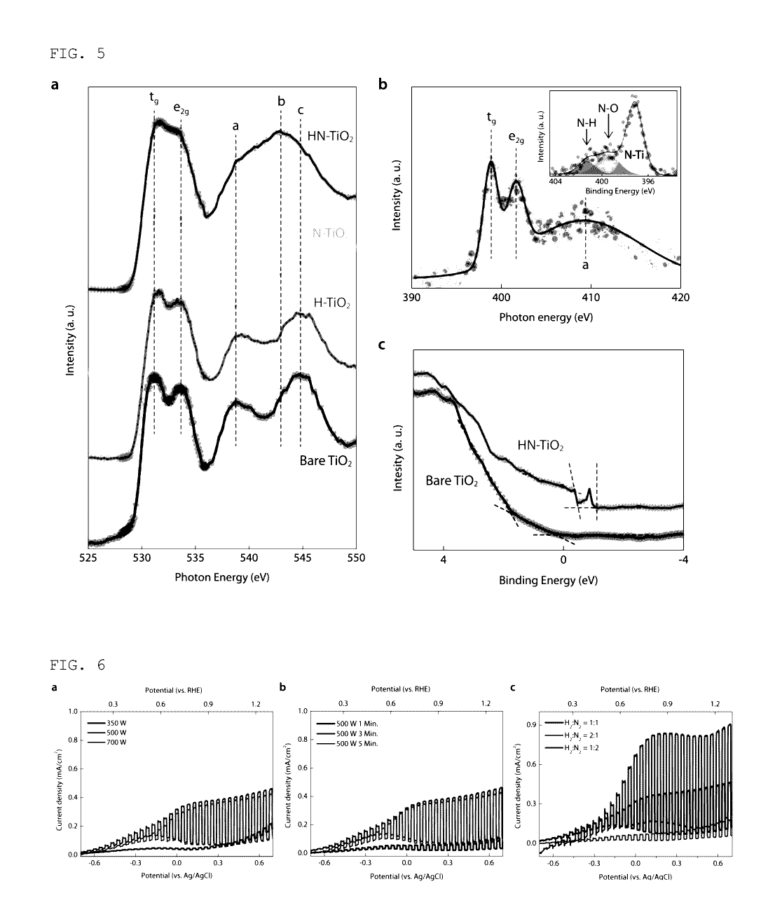

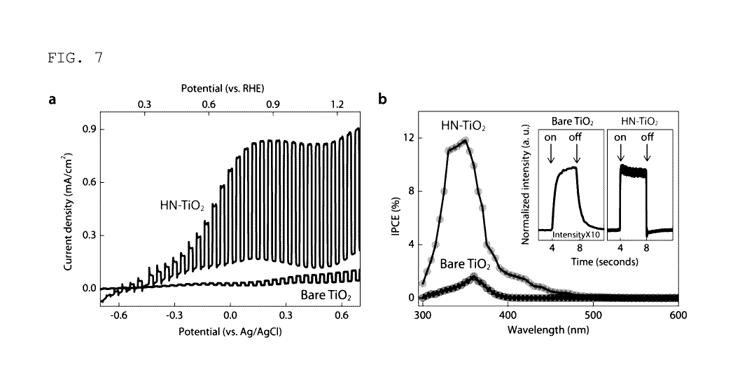

FIG. 6 illustrates conditions for H₂/N₂ mixed gas plasma treatment optimized according to a photoelectrochemical catalysis evaluation using 0.1 M NaClO₄ aqueous solution (pH 7) as an electrolyte, a platinum counter electrode and an Ag/AgCl reference electrode. As a result of measuring a water-oxidation photocurrent amount with variations in plasma generation output (FIG. 6a), plasma treatment time (FIG. 6b) and the mixing ratio of H₂/N₂ gas (FIG. 6c), it was observed that the highest photocatalytic performance is achieved when a plasma ball generated using the H₂/N₂ mixed gas in a mixing ratio of hydrogen:nitrogen=1:2 with 500 W output power at room temperature contacts with the surface of the metal oxide thin film to treat the same.

Likewise, FIG. 7 also illustrates comparison and evaluation results of photoelectrochemical catalysis reactivity of the sample (HN—TiO₂) with the plasma treatment under the optimum condition induced in FIG. 6 and the untreated sample (bare TiO₂). In the photocurrent-voltage curve in FIG. 7a, it was observed that the photocurrent amount of the HN—TiO₂ sample emitting light at 1.23 V_{RHE} (potential for degrading water and generating hydrogen and oxygen) has increased by 9 times or more, compared to the bare TiO₂.

FIG. 7b illustrates photocatalytic water oxidation reaction efficiency with respect to wavelengths of light. Herein, it was observed that the bare TiO₂ exhibits photoreaction in only the UV light range (300 nm to 400 nm) while HN—TiO₂ has an extended range of reaction up to the visible light region. In particular, it was found that an integral value of the visible light region (400 nm to 600 nm) curve only of the HN—TiO₂ sample is larger than an integral value of a curve as the sum of overall wavelength ranges of the bare TiO₂. In fact, as a result of separating light with UV wavelength and light with visible light wavelength from each other, then, measuring the respective photocurrent amounts, the HN—TiO₂ sample showed the photocurrent amount (0.094 mA cm⁻²) generated from the light only at the visible light wavelength, which is higher than the photocurrent amount of the bare TiO₂ (0.041 mA cm²) generated by the light with the sum of UV light and visible light wavelengths. Meanwhile, photoreactivity of the HN—TiO₂ sample is gradually decreased as the number of waves per wavelength increases in the visible light region, then, rapidly approaches 0% from a point at 470 nm, and this result demonstrated that the VBM is raised due to the above-described Ti—Nₛ binding to thus attain effects of decreasing the band-gap to about 2.7 eV.

The inset of FIG. 7b illustrates a graph of chopped photocurrent time curve with normalization of their photocurrent intensity. Herein, it was observed that the HN—TiO₂ sample exhibits instant excitation and relaxation of the generated photocurrent depending on light irradiation and blocking thereof. On the other hand, the photocurrent of the bare TiO₂ was very slowly increased to the maximum photocurrent value when becoming light, while being decreased slowly to the minimum value even if the light emission is blocked. The reason of such a phenomenon is that the bare TiO₂ has a very low transportation rate of electrons and holes generated by the light from the inside to the outside of a particle, as compared to that of HN—TiO₂, therefore, a time required to reach a steady-state in the amounts of electrons and holes moving toward the outside of the particle is also much longer than that of HN—TiO₂.

The above-described slow transfer phenomenon of the electron-hole has caused such a phenomenon that the electrons and holes still accumulated inside the particle without moving to the outside thereof are gradually transferred to the outside and slowly decreased, therefore, it looks as if the photoreaction still exists even after the light is blocked. Further, referring to an HN—TiO₂ photocurrent curve, since an overshooting phenomenon occurs during light irradiation while a lower value of current amount than the dark current value in the steady-state is observed during light blocking, it was determined that the HN—TiO₂ sample involves a Shockley-Read-Hall (SRH) recombination that is a phenomenon occurring when an electron donor or electron acceptor level is present at a deep level inside the band-gap of a semiconductor material. In the present case, this was observed as an effect occurring due to Ti—Nₛ and Vₒ energy levels shown in the graph of FIG. 3.

Consequently, an electron carrier density is increased by the high concentration of oxygen vacancy, and the electron-hole pairs generated by sensitization of the light in the visible light region are also increased. Furthermore, due to the energy level generated at the surface of the particle, the electrons and holes generated inside the particle can be rapidly moved toward the outside. Finally, the number of electrons and holes participating in the oxidation/reduction reaction are increased to thus improve photocatalysis efficiency.

The terms or words used in the specification and claims of the present invention should not be construed as limited to a lexical meaning, and should be understood as appropriate notions by the inventor based on that he/she is able to define terms to describe his/her invention in the best way to be seen by others. Therefore, embodiments and drawings described herein are simply exemplary and not exhaustive, and it will be understood that various modifications and equivalents may be made to take the place of the embodiments.

The metal oxide material obtained by the H₂/N₂ mixed gas plasma treatment according to the present invention may be employed not only in a direct conversion catalyst for converting solar energy into a compound such as hydrogen and CO₂ conversion but also in anodic electrode materials for electrochemical energy conversion and storage fields, as well as other applications directly associated with metal oxide semiconductor catalysts such as a gas sensing catalytic material.

Further, non-harmful effects to the human body and environment and fluorescent light sensitive properties may be practically utilized in a variety of applications including, for example: building interior/exterior materials; semi-permanent anti-fouling agents for garments, masks, etc.; offensive odor removers; preservatives; or tooth whitening agents. Moreover, due to strong UV reactivity and high organic matter oxidation effects, the metal oxide material of the present invention may be used as an air or water purification catalyst utilizing UV LED light.

What is claimed is:

1. A method for improving solar energy conversion efficiency of a metal oxide semiconductor photocatalyst, comprising: a first process of preparing a metal oxide thin film having n-type semiconductor properties; and a second process of performing a hydrogen and nitrogen mixed gas plasma treatment on the metal oxide thin film.

2. The method according to claim 1, wherein the metal is at least one selected from Ti, V, Fe, Ni, Cu, Zn, Sn, Ta, W and Bi.

3. The method according to claim 1, wherein the second process includes contacting a plasma sphere formed by an H₂/N₂ mixed gas plasma reaction with a surface or particle of the metal oxide thin film in a single process at room temperature to enhance photocatalytic properties and efficiency.

4. The method according to claim 3, wherein radicals included in the H₂/N₂ mixed gas plasma are hydrogen radicals (H⁺), nitrogen radicals (N⁺) and hydrogenated nitrogen radicals (NHₓ⁺).

5. The method according to claim 1, wherein a mixing ratio of hydrogen gas to nitrogen gas in the second process is 1:1, 1:2 or 1:3.

6. The method according to claim 1, wherein the metal oxide thin film shows metal oxide properties maintained inside while having an amorphous core-shell structure formed on the outside thereof by the hydrogen and nitrogen plasma treatment.

7. A catalyst for direct conversion of solar energy into a compound, comprising the metal oxide material formed by the H₂/N₂ mixed gas plasma treatment according to claim 1, which is adapted to directly convert the solar energy into the compound by hydrogen and CO₂ conversion.
